(19) United States
(12) Patent Application Publication
(10) Pub. No.: US 2025/0306903 A1
(43) Pub. Date: Oct. 2, 2025

(54) Method and Device for Update of Target File of Automotive Open System Architecture

(71) Applicants: Robert Bosch GmbH, Stuttgart (DE); Bosch Automotive Products (Suzhou) Co. Ltd., Suzhou (CN)

(72) Inventors: Xian Yang, Suzhou (CN); Longan Jin, Suzhou (CN)

(21) Appl. No.: 19/087,480

(22) Filed: Mar. 22, 2025

(30) Foreign Application Priority Data
Mar. 27, 2024 (CN) 2024 1036 2042.3

(51) Int. Cl. G06F 8/65

(52) U.S. Cl. CPC G06F 8/65

(57) ABSTRACT

A method for updating a target file of an automotive open system architecture includes (i) obtaining an extensible markup language file generated in response to a modification of a target variable of a post-build attribute type and a corresponding first target file to be updated, (ii) obtaining address information of the target variable in the first target file based on the extensible markup language file, and (iii) updating a value of the target variable in the first target file based on the obtained address information to generate an updated second target file. A target file update device, a computing device, a computer-readable storage medium, and a computer program product for an automotive open system architecture is also disclosed.

This application claims priority under 35 U.S.C. § 119 to application no. CN 2024 1036 2042.3, filed on Mar. 27, 2024 in China, the disclosure of which is incorporated herein by reference in its entirety.

The present disclosure relates to the field of automotive open system architecture, in particular, to a target file update method, a target file update device, a computing device, a computer-readable storage medium, and a computer program product of an automotive open system architecture.

### BACKGROUND

Automotive Open System Architecture (Autosar), is a collaborative development framework for an automotive electronics system shared by various automobile manufacturers, parts suppliers and various research and service organizations around the world, and an open automotive control unit (ECU) standard software architecture.

The Autosar basic module includes a very large number of parameters, which define three configuration parameter categories: Pre-compile time parameters (parameters of pre-compile attribute type), Link time parameters (parameters of link time attribute type), and Post-build time parameters (parameters of post-build attribute type). Among them, the Pre-compile time parameters mainly contain some macro definitions, which are mainly used to enable/disable some optional functions, and provide options to optimize the size or performance of executable files. This type of parameter is generated in a file such as *.cfg.h (macro definition, etc.)/*.cfg.c (constant parameter definition, etc.) in a code generation phase. Most of these parameters are macro definitions, so static codes of modules are required to be provided in the form of source codes. If this type of parameter changes, the module needs to be recompiled. Link time parameters can be determined mainly in the Link phase, such as the call-back function of the module configuration (defined in other source code files). Post-build time parameters are generated in the *.lcfg.h/*.lcfg.c file and the like during the code generation phase. The structure of such parameters mainly applicable to some parameters is certain, but the content is uncertain when the electronic control unit (ECU) is produced, or the parameters are likely to change after the ECU is produced.

### SUMMARY

An object of the present disclosure is to provide a target file update method of the automotive open system architecture and a target file update device of the automotive open system architecture. The target file update method and device of the automotive open system architecture according to the present disclosure can achieve rapid update and iteration of products in particular, with convenient configuration and benefits to save development time and reduce development costs.

To this end, a target file update method of an automotive open system architecture is provided according to a first aspect of the present disclosure, comprising: obtaining an extensible markup language file generated in response to a modification of a target variable of a post-build attribute type and a corresponding first target file to be updated; obtaining address information of the target variable in the first target file based on the extensible markup language file; updating a value of the target variable in the first target file based on the obtained address information to generate an updated second target file.

In addition, according to a second aspect of the present disclosure, a target file update device of an automotive open system architecture is provided, comprising: a file acquisition module for acquiring an extensible markup language file generated in response to a modification of a target variable of a post-build attribute type and a corresponding first target file to be updated; an address information acquisition module for obtaining address information of the target variable in the first target file based on the extensible markup language file; and a target file update module for updating a value of the target variable in the first target file based on the obtained address information to generate an updated second target file.

The device according to the second aspect of the present disclosure may be implemented, for example, in the form of software or hardware or in the form of a hybrid of software/hardware.

In addition, a computing device is provided according to a third aspect of the present disclosure, the computing device comprising: a processor; and a memory for storing computer executable instructions that, when executed, cause the processor to execute the method described above.

In addition, a computer-readable storage medium is provided according to a fourth aspect of the present disclosure, the computer-readable storage medium having computer executable instructions stored thereon, the computer executable instructions being used to execute the method described above.

In addition, a computer program product is provided according to a fourth aspect of the present disclosure, the computer program product being tangibly stored on a computer-readable storage medium and including computer executable instructions that, when executed, cause at least one processor to perform the method described above.

The above technical solution according to the present disclosure has the following advantages, among others. A customer can directly modify a target file corresponding to the variable of the post-build attribute type to obtain an updated target file without modifying the entire set of source codes and recompiling and linking, which enables rapid update and iteration of products, and has the advantages of short development cycles, low costs and low open source risks.

### BRIEF DESCRIPTION OF THE DRAWINGS

Other features and advantages of the present disclosure will be better understood by the following preferred embodiments described in detail in conjunction with the accompanying drawings, wherein:

FIG. 1 shows an exemplary flow chart of a method for updating a target file of an automotive open system architecture, according to one example of the present disclosure.

FIG. 2 shows an example flow chart of a method for updating a target file of an automotive open system architecture, consistent with another example of the present disclosure.

FIG. 3 shows an exemplary block diagram of a target file update device for an automotive open system architecture, according to one example of the present disclosure.

FIG. 4 shows an exemplary block diagram of a computing device, according to one example of the present disclosure.

### DETAILED DESCRIPTION

The implementation and use of the examples are discussed in detail below. However, it will be understood that the specific examples discussed exemplify only certain ways of practicing and using the present disclosure, and are not limiting the scope of the present disclosure.

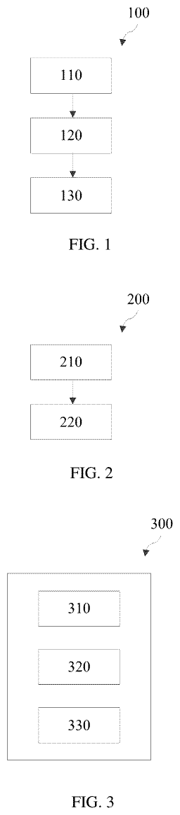

As shown in FIG. 1, it is an exemplary flow chart of a method 100 for updating a target file of an automotive open system architecture, the method 100 specifically comprising the following steps:

Step 110, acquiring an extensible markup language file generated in response to a modification of a target variable of a post-build attribute type and a corresponding first target file to be updated. Here, the method of obtaining the extensible markup language file generated in response to a modification of a target variable of the post-build attribute type may be: generating corresponding extensible markup language file after configuration modification through tools such as Vector DaVinci Configurator Pro (an Autosar configuration tool for configuring and integrating Autosar software components, modules and parameters), Elektrobit Tresos Studio (a centralized development environment that can be used for Autosar software development and integration, providing rich functions such as code generation, configuration management and simulation), ETAS ASCET-DEVELOPER (a tool kit for developing AUTOSAR software, providing model-driven development capabilities and integration with other tools), dSPACE SystemDesk (a tool for designing, simulating, and generating Autosar system descriptions, providing a graphical interface that enables developers to quickly design and configure the system), and MathWorks Simulink. The first target file is an object code before the update, and the object code is a machine executable file that contains machine instructions in binary form produced by a compiler. The object code is a machine executable code that the compiler converts a source code into. Typically, the source code needs to be compiled to reflect changes in the object code. In some examples, the target variable of the post-build attribute type may include sequence information and version information of the product.

Step 120, obtaining address information of the target variable in the first target file based on the extensible markup language file (Arxml file). The Arxml file plays a key role in data transmission and storage as a general-purpose configuration file or database file under the Autosar architecture. In the present example, Arxml provides the address information of the target variable in the corresponding target file as the corresponding configuration file generated by modifying the target variable of the post-build attribute type. In some embodiments, the target variable includes preset information including a storage location, a storage format, a sorting method, and/or an alignment method of the target variable in a target file. The value of the target variable before and after the modification remains unchanged in the storage location, storage format, sorting method, and/or alignment method in the target file.

In some examples, the Arxml file includes a system configuration file (System Configuration, which includes description information of a plurality of ECUs, describes information sent or received between the ECUs and interface and port description information across ECU components. System Configuration describes the interaction information between the ECUs from the perspective of the vehicle system), an ECU extract file (ECU Extract, which is a subset of System Configuration, describes the information sent or received by a single ECU, also contains the software components (SWC, Software Components) contained within a single ECU and detailed information of SWC, such as interface definitions and port definitions. ECU Extract is consistent with the communication matrix currently used), an ECU configuration file (ECU Configuration, which belongs to the category of a single ECU. It describes all information after configuration of SWC Description, ECU Extract and BSW (Basic Software) modules), an SWC description file (SWC Description, describes all user-defined design information, including SWC definition, operating entity, interface, and port data type definition) and a BSW module description file (BSW Module Description, which belongs to standard module information. Module information is related to the code package, and may differ from suppliers to suppliers, but all comply with the AUTOSAR standard definition.

Step 130, updating the value of the target variable in the first target file based on the obtained address information to generate an updated second target file. By directly modifying and replacing the value of the variable in the corresponding location of the first target file, the corresponding second target file required for configuration update is quickly obtained, and there is no need to modify and compile the source code again due to changes in product configuration. The implementation process is simple and user operation is easy.

In some examples, the modification method of the target variable of the post-build attribute type comprises: modifying via a flash erase tool, Unified Diagnostic Services (UDS) and/or a booting program (Bootloader).

Based on the method 100, the existing Autosar tool (such as Vector DaVinci Configurator Pro) can be updated, and a tool for updating the target file of the variable of the post-build attribute type is newly added. The input of the tool includes Autosar extensible markup language file (Arxml) and the corresponding target file before the update, and the output is the target file corresponding to the modified configuration. The tool directly modifies and replaces the variable at the corresponding location of the original target file corresponding to the configuration modification to obtain the required target file, thereby improving the development efficiency of the Autosar tool and making it more convenient for users to use.

As shown in FIG. 2, it is an exemplary flow chart of a method 200 for updating a target file of an automotive open system architecture according to another example of the present disclosure, the method 200 specifically comprising the following steps:

Step 210, acquiring a first extensible markup language file (first Arxml file) generated in response to a modification of a target variable of the post-build attribute type and a corresponding first target file to be updated. Further obtaining a second extensible markup language file (second Arxml file) generated in response to a modification of a target variable of a pre-compile attribute type and/or a link time attribute type.

Step 220, obtaining the address information of the target variable in the first target file based on the extensible markup language file, and updating the value of the target variable in the first target file based on the obtained address information to generate an updated second target file. Further generating a source file (source code) based on the first and second extensible markup language files; compiling the source file to generate a corresponding updated third target file.

In the present example, the user or configuration engineer not only modifies the variable of the post-build attribute type, but also modifies the variable of the pre-compile and/or link time attribute type, to generate a corresponding first Arxml file and a second Arxml file. Here, the first Arxml file can not only acquire the second target file through a first path, that is, acquire an updated target file by directly modifying and replacing the target file corresponding to the variable of the post-build attribute type, but also obtain the updated target file through a second path, that is, by generating a source file and compiling the same. It is to be understood that the acquisition paths of the two updated target files do not conflict and can be synchronized. Preferably, the second path is triggered when and only when the variable of the pre-compile and/or link time attribute type is modified. The other implementation methods of the present example are similar to the methods described above, so they will not be repeated here.

As shown in FIG. 3, it is an exemplary block diagram of a target file update device 300 for an automotive open system architecture according to another example of the present disclosure, the device 300specifically comprising: a file acquisition module 310 for acquiring an extensible markup language file generated in response to a modification of a target variable of a post-build attribute type and a corresponding first target file to be updated; an address information acquisition module 320 for obtaining address information of the target variable in the first target file based on the extensible markup language file; and a target file update module 330 for updating a value of the target variable in the first target file based on the obtained address information to generate an updated second target file. The embodiment of the present example is similar to the method described above, so it will not be repeated here.

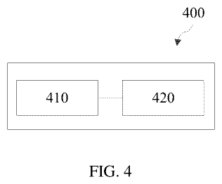

As shown in FIG. 4, it is an exemplary block diagram of a computing device 400 of another example of the present disclosure. The computing device 400 includes a processor 410 and a memory 420 coupled with the processor 410. The memory 420 is used to store computer executable instructions that, when executed, cause the processor 410 to perform the methods of the above examples (e.g., any one or more steps of the above described methods).

Alternatively, the above described methods can be implemented by a computer-readable storage medium. Computer-readable program instructions for performing various examples of the present disclosure are carried on the computer-readable storage medium. The computer-readable storage medium may be a tangible device that can maintain and store instructions used by an instruction execution device. The computer-readable storage medium may be, for example, but not limited to, an electrical storage device, a magnetic storage device, an optical storage device, an electromagnetic storage device, a semiconductor memory device, or any suitable combination of the above. More specific examples of the computer-readable storage medium (a non-exhaustive list) comprise: a portable computer disk, a hard disk, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, a mechanical encoding device, such as a punch card and a protrusion structure in grooves with instructions stored thereon, as well as any suitable combination of the above. The computer-readable storage medium used herein is not to be construed as transient signals per se, such as radio waves or other freely propagating electromagnetic waves, electromagnetic waves propagating through waveguides or other transmission media (e.g., light pulses through fiber optic cables), or electrical signals transmitted through wires.

Thus, in another example, the present disclosure proposes a computer-readable storage medium having computer executable instructions stored thereon that are used to carry out the methods of various examples of the present disclosure.

In another example, the present disclosure proposes a computer program product that is tangibly stored on a computer-readable storage medium and includes computer executable instructions that, when executed, cause at least one processor to perform the methods of various examples of the present disclosure.

In general, the various exemplary examples of the present disclosure may be implemented in hardware or a dedicated circuit, software, firmware, logic, or any combination thereof. Some aspects may be implemented in hardware, while other aspects may be implemented in firmware or software that may be executed by a controller, a microprocessor, or other computing devices. Where aspects of the examples of the present disclosure are illustrated or described as block diagrams, flowcharts, or using some other graphical representation, it is to be understood that the blocks, devices, systems, techniques, or methods described herein may be implemented, as non-limiting examples, in hardware, software, firmware, dedicated circuits or logic, general purpose hardware or controllers, or other computing devices, or some combinations thereof.

The computer-readable program instructions or computer program products used to execute various examples of the present disclosure can also be stored in the cloud. When a call is required, a user can access the computer-readable program instructions stored in the cloud for performing one example of the present disclosure via a mobile internet, fixed network or other networks, thereby implementing the technical solutions disclosed in accordance with the various examples of the present disclosure.

Although examples of the present disclosure have been described in reference to several specific examples, it is to be understood that examples of the present disclosure are not limited to the specific examples disclosed. Embodiments of the present disclosure are intended to encompass various modifications and equivalent arrangements included within the spirit and scope of the appended claims. The scope of claims is consistent with the broadest interpretation, so as to include all such modifications and equivalent structures and functions.

For those skilled in the art, various modifications or variations can be made to the above preferred examples without departing from the spirit of the present disclosure, and these modifications or variations do not depart from the scope of the present disclosure.

What is claimed is:

1. A method for updating a target file of an automotive open system architecture, comprising:
obtaining an extensible markup language file generated in response to a modification of a target variable of a post-build attribute type and a corresponding first target file to be updated;
obtaining address information of the target variable in the first target file based on the extensible markup language file; and
updating a value of the target variable in the first target file based on the obtained address information to generate an updated second target file.

2. The method for updating a target file of an automotive open system architecture according to claim 1, wherein the extensible markup language file is a first extensible markup language file, and the method further comprises:
obtaining a second extensible markup language file generated in response to a modification of a target variable of a pre-compile attribute type and/or a link time attribute type;
generating a source file based on the first and second extensible markup language files; and
compiling the source file to generate a corresponding updated third target file.

3. The method for updating a target file of an automotive open system architecture according to claim 1, wherein the target variable comprises preset information, and the preset information comprises a storage location, a storage format, a sorting method, and/or an alignment method of the target variable in a target file.

4. The method for updating a target file of an automotive open system architecture according to claim 1, wherein the target variable of the post-build attribute type comprises sequence information and version information of a product.

5. The method for updating a target file of an automotive open system architecture according to claim 1, wherein the modification method of the target variable of the post-build attribute type comprises: modifying via a flash erase tool, unified diagnostic services, and/or a booting program.

6. The method for updating a target file of an automotive open system architecture according to claim 1, wherein the extensible markup language file comprises a system configuration file, an electronic control unit extract file, an electronic control unit configuration file, a software component description file, and/or a basic software module description file.

7. A device for updating a target file of an automotive open system architecture, comprising:
a file acquisition module configured to obtain an extensible markup language file generated in response to a modification of a target variable of a post-build attribute type and a corresponding first target file to be updated;
an address information acquisition module configured to obtain address information of the target variable in the first target file based on the extensible markup language file; and
a target file update module configured to update a value of the target variable in the first target file based on the obtained address information to generate an updated second target file.

8. A computing device, comprising:
a processor; and
a memory for storing computer executable instructions that, when executed, cause the processor to execute the method according to claim 1.

9. A computer-readable storage medium having computer executable instructions stored thereon, the computer executable instructions being used to execute the method for updating a target file of an automotive open system architecture according to claim 1.

10. A computer program product tangibly stored on a computer-readable storage medium and including computer executable instructions that, when executed, cause at least one processor to perform the method for updating a target file of an automotive open system architecture according to claim 1.
